(19) United States
(12) Patent Application Publication
(10) Pub. No.: US 2013/0341272 A1
(43) Pub. Date: Dec. 26, 2013

(54) Dewatering Systems and Methods for Biomass Concentration

(71) Applicant: ALGAE SYSTEMS, LLC, Carson City, NV (US)

(72) Inventors: Sherwin Gormly, Carson City, NV (US); Matthew Atwood, Chicago, IL (US); Andrew Septimus, New York, NY (US); John Perry Barlow, Mill Valley, CA (US)

(73) Assignee: Algae Systems, LLC, Carson City, NV (US)

(21) Appl. No.: 13/828,143

(22) Filed: Mar. 14, 2013

Related U.S. Application Data
(60) Provisional application No. 61/664,532, filed on Jun. 26, 2012.

(51) Int. Cl. B01D 61/58

(52) U.S. Cl. CPC B01D 61/58
USPC 210/641; 210/259; 210/130; 210/182

(57) ABSTRACT

Ultra-low energy membrane-based dewatering systems and methods are provided herein. Dewatering systems of the invention employ both micro-filtration and forward osmosis, and optionally employ settling, to concentrate biomass at a low concentration, such as about 0.5 g/L, to a concentration of about 50 g/L or more.

### CROSS-REFERENCE TO RELATED APPLICATIONS

This application claims the benefit of U.S. Provisional Patent Application No. 61/664,532 filed on Jun. 26, 2012 and entitled “Dewatering Systems and Methods for Algae Concentration” which is incorporated by reference herein. This application is related to U.S. Non-Provisional Patent Application No. 13/______ filed on even date herewith and entitled “Integrated Biorefinery” (attorney docket number 5658.18 (SMC)) which is also incorporated herein by reference.

### BACKGROUND OF THE INVENTION

1. Field of the Invention

The invention relates generally to the field of renewable energy and more particularly to systems and methods for concentrating dilute biomass suspensions.

2. Description of the Prior Art

One of the major limitations to the use of algae as a biomass feedstock for the production of fuels and other organically-derived products is the energy demand for harvesting and dewatering the algae to the point where the biomass can suitably be fed into the fuel making/separation process. Algae biomass production is most rapid and effective at densities of less than 1 g/L (0.1%) solids. Most separation processes to extract lipids and the other components of algae with fuel making potential require densities well in excess of 10% solids. Bridging this gap using known methods generally exceeds the fuel value of the algae to be processed, thus rendering the entire algae bio-fuels process energy negative and economically unfavorable.

Generally, the most efficient processes for concentrating dilute biomass solutions are membrane processes. However membrane processes, if not carefully designed, easily foul and then fail to perform at concentrations well below the point where high-density solids production can actually be achieved. Microfiltration is well understood to provide excellent rejection of micro-algae to relatively high concentrations in the 2% (20 g/L) to 4% (40 g/L) range but will not operate well at still higher concentrations. Another process is required to increase the concentrations of these suspensions to the more useful 8% (80 g/L) to 20% (200 g/L) range.

This concentration mid-range corresponds to a transition from a liquid suspension to a wet solid which is less flowable. However, the concentrated biomass at this stage is still predominantly water and thus the energy required to achieve further dewatering using heat is prohibitive. Convectional centrifuges, belt presses and other well-known solids dewatering devices have been proposed for this range, but are generally energy prohibitive if not used sparingly and do a poor job of actually trapping all the algae. Also, these more commonly known solids dewatering technologies have the additional drawback of producing a large amount of liquid waste that must be treated, and that treatment cost must be counted against the fuel value recovered.

### SUMMARY

The integration of compression settling (or low power centrifugation) with high solids handling forward osmosis provides one way to bridge this critical mid-range problem area for algae dewatering. As provided herein, forward osmosis provides a low energy non-fouling membrane for liquid/solids separation that can augment, or replace, conventional solids separations in the 5% to 20% solids range by trapping and concentrating any part of the liquid that cannot be concentrated by simple density based separation alone.

An exemplary dewatering system of the present invention comprises a first filtration unit, a second filtration unit, and a settling system in fluid communication between the first and second filtration units. The first filtration unit includes a microfiltration membrane, an input, a fresh water output and a concentrate output. The settling system can comprise compression settling system, a settling tank, or a settling pond, in various embodiments, and includes a solids collection system, an input coupled to the concentrate output of the first filtration unit, a solids output from the solids collection system, and a supernatant output. The solids collection system optionally comprises a cone bottom tank or a bottom sweep system. The second filtration unit includes a forward osmosis membrane, a supernatant input coupled to the supernatant output of the settling system, a draw solution input, a draw solution output, and a biomass output coupled to the input of the first filtration unit. The microfiltration membrane includes pores with a pore size range of 0.45 μm±0.2 μm, in some embodiments.

In various embodiments, the exemplary dewatering system further comprises a bypass valve disposed between the first filtration unit and the settling system, plumbing connected between the bypass valve and the second filtration unit, and a controller configured to direct the concentrate output from the first filtration unit to the second filtration unit, bypassing the settling system, responsive to a system upset event. Various embodiments can also further comprise one or both of a third filtration unit including a microfiltration membrane and a fourth filtration unit including a forward osmosis membrane. The filtration unit including the microfiltration membrane is disposed between the settling system and the second filtration unit and is configured to be used to pre-concentrate the supernatant from the supernatant output. The filtration unit including the forward osmosis membrane is configured to receive an output from the solids output of the solids collection system and is further configured to concentrate the output from the solids output.

Another exemplary dewatering system of the present invention comprises a first filtration unit, a second filtration unit, and a thermal trim system. The first filtration unit includes a microfiltration membrane including pores having a pore size in a range of 0.45 μm±0.2 μm, for example, an input, a fresh water output and a concentrate output. The second filtration unit includes a forward osmosis membrane, a supernatant input coupled to the concentrate output of the first filtration unit, a draw solution input, a draw solution output, and a biomass output for producing a concentrated supernatant solution. The thermal trim system is coupled to the biomass output of the second filtration unit and configured to heat the concentrated supernatant solution to drive off water from the concentrated supernatant solution to form a solid biomass product.

The present invention also provides methods for dewatering biomass such as algae. An exemplary method comprises filtering a low concentration suspension of biomass with a microfiltration membrane to produce clarified water and a concentrated suspension of biomass, settling the concentrated suspension of biomass to produce a solid biomass product and a supernatant solution. The low concentration suspension of biomass can have a concentration in a range of 0.1 g/L to 4 g/L, in some embodiments, while in various embodiments the concentrated suspension of biomass has a concentration in a range of 10 g/L to 40 g/L. In still other embodiments the solid biomass product has a concentration of 8% to 20%. The method further comprises passing the supernatant solution and a salt solution across opposite sides of a forward osmosis membrane to produce a less concentrated salt solution and a more concentrated supernatant solution, and adding the more concentrated supernatant solution into the low concentration suspension of biomass.

In various embodiments the method further comprises passing the solid biomass product and a second salt solution across opposite sides of a second forward osmosis membrane to produce a second less concentrated salt solution and a drier solid biomass product. The method optionally also can further comprise filtering the supernatant solution with a microfiltration membrane to remove further water therefrom prior to passing the supernatant solution and the salt solution across opposite sides of the forward osmosis membrane.

An exemplary method of dewatering biomass comprises filtering a low concentration suspension of biomass with a microfiltration membrane to produce clarified water and a supernatant solution of biomass, passing the supernatant solution and a salt solution across opposite sides of a forward osmosis membrane to produce a less concentrated salt solution and a more concentrated supernatant solution, and thermally trimming the more concentrated supernatant solution to produce a solid biomass product.

In this way the biomass that was not concentrated into the solid biomass product is captured and returned at little additional energy cost. Additionally, the water removed from the biomass through these methods either comes out as reusable water from microfiltration or dilutes an osmotic agent such as salt in solution, but in either situation the release of nitrogen and phosphorus with the water is negligible as it tends to stay with the biomass. Thus, the methods are particularly suitable where the biomass is cultivated in wastewater.

### BRIEF DESCRIPTION OF DRAWINGS

FIG. 1 is a schematic representation of a dewatering system according to an exemplary embodiment of the present invention.

FIG. 2 is a schematic representation of a dewatering system according to another exemplary embodiment of the present invention.

FIG. 3 is a schematic representation of a dewatering system according to still another exemplary embodiment of the present invention.

FIG. 4 is a flowchart representation of a method for dewatering biomass according to an exemplary embodiment of the present invention.

FIG. 5 is a flowchart representation of a method for dewatering biomass according to another exemplary embodiment of the present invention.

### DETAILED DESCRIPTION OF THE INVENTION

The present invention provides ultra-low energy membrane-based dewatering systems, comprising both micro-filtration and forward osmosis, capable of concentrating an algal suspension having a low concentration, such as about 0.5 g/L, to a concentration of more than 50 g/L to as much as 150 g/L or more. Endpoint concentrations depend on the requirements of the downstream conversion processes, and can be controlled using forward osmosis.

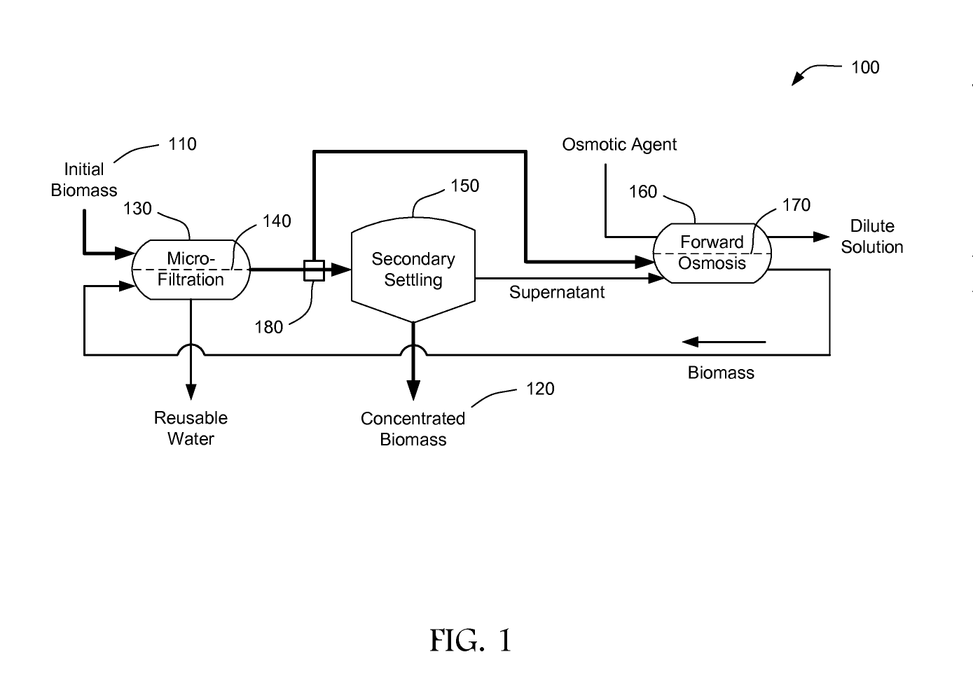

FIG. 1 illustrates an exemplary dewatering system 100 of the present invention for dewatering an initial biomass 110 in suspension, such as harvested algae, that beneficially also treats all of the removed water drawn from the suspension. In some embodiments, the initial biomass 110, as received, has undergone a pre-concentration step through settling to yield a pre-concentrate. Dewatering systems 100 of the present invention are capable of concentrating the suspension by a factor of 20 or more. For example, algae in suspension at an initial concentration of about 1 g/L to about 2 g/L can be brought to a concentration of 20 g/L to 200 g/L in the concentrated biomass 120. Heavy lines in FIG. 1 trace a path of increasing biomass concentration through the dewatering system 100.

A source of the initial biomass 110 is preferably collocated with the dewatering system 100 to reduce the energy cost of transporting large quantities of water over extended distances. The dewatering system 100 can likewise be collocated with systems for producing fuels or other products from the dewatered biomass. Similarly, the dewatering system 100 can be further collocated with a source of an osmotic agent, like salt water or brine. Such sources can include oceans, seas, salt lakes, underground brine reservoirs, wastewater from industrial processing, and so forth. In some embodiments, the source of the initial biomass 110 uses industrial, agricultural, or municipal wastewater as a growth medium for the initial biomass. The dewatering system 100 can also be configured to float, in some embodiments, such as with pontoons, and can also comprise part of an integrated production system, such a disclosed in the “Integrated Biorefinery” application noted above.

The dewatering system 100 comprises a first filtration unit 130 including a microfiltration membrane 140, a settling system 150, and a second filtration unit 160 including a forward osmosis membrane 170. The first filtration unit also includes an input for receiving the initial biomass 110, a fresh water output, and a concentrate output that provides a concentrated suspension of a biomass such as algae. The initial biomass 110 can comprise a low concentration suspension of algae, for example, 0.18% by weight of algae in water.

In FIG. 1, the initial biomass 110 is first received in a micro-filtration system 130. The filtration system 130 is effective to filter a low concentration suspension of biomass using the microfiltration membrane 140 to produce clarified water suitable for reuse (human contact disinfection to meet agricultural reuse standards for developed systems) and a concentrated suspension of algae, for example, about 2.0% to about 3.1% by weight of algae in water. In various embodiments the microfiltration membrane 140 includes pores with a pore size range of 0.45 μm±0.2 μm.

The settling system 150 optionally can comprise a compression settling system, a settling tank, a settling pond, or a centrifuge, in various embodiments. In some embodiments the settling system 150 includes a solids collection system such as a cone bottom tank or a bottom sweep system. The settling system 150 also comprises an input coupled to the concentrate output of the first filtration unit 130, a solids output from the solids collection system, and a supernatant output. The solids output provides the fully concentrated biomass 120. The supernatant liquid from the settling system 150 may still contain a significant amount of biomass, though highly diluted. This 95% dewatering and pre-concentration of the biomass to greater than 2% enhances both the total settleablility and endpoint concentration from settling by a well understood mechanism know as compression settling which also significantly lowers the time required for settling to achieve a highly concentrated sludge.

The second filtration unit 160 employs forward osmosis to treat the supernatant liquid recovered from settling system 150 to harvest any remaining biomass therein as well as to provide a clean salt water discharge. Forward osmosis is attractive in these methods because the membranes do not foul easily. The second filtration unit 160 includes the forward osmosis membrane 170, a supernatant input coupled to the supernatant output of the settling system 150, a draw solution input, a draw solution output, and a biomass output coupled to the input of the first filtration unit. The draw solution input is coupled to a source of an osmotic agent like salt water or brine. Such sources can include oceans, seas, salt lakes, underground brine reservoirs, wastewater from industrial processing, and so forth. Generally, a draw solution with a high concentration of the osmotic agent is favored to drive the osmosis.

As described in greater detail below, the draw solution on one side of the forward osmosis membrane 170 becomes a more dilute solution with passage through the second filtration unit 160 by drawing water from the supernatant liquid recovered from the settling system 150. Thus, the draw solution input and the draw solution output are on opposite sides of the second filtration unit 160 and on the same side of the forward osmosis membrane 170. The dilute solution can be returned to the source, in some embodiments. Another option is to recover clean water from the dilute solution through the use of reverse osmosis (not shown) to re-concentrate the solution and then return the re-concentrated solution to the draw solution input.

The solids in the supernatant liquid become more concentrated with passage through the second filtration unit 160 from the supernatant input to the biomass output as water is drawn from the supernatant across the forward osmosis membrane 170. Thus, the supernatant input and biomass output are on opposite sides of the second filtration unit 160 and on the same side of the forward osmosis membrane 170, and opposite the side holding the osmotic agent. An exemplary solids concentration in the solution coming out of the biomass output is about 0.7% solids by weight.

Forward osmosis is a process by which an ultrafiltration membrane is operated with an osmotic agent like salt or sugar in solution on a permeate side of the membrane, and a solution to be dewatered on the opposite side of the membrane. Water is drawn across the membrane by the osmotic potential of the osmotic agent on the permeate side. The osmotic potential drives the flux across the membrane, requiring only the energy necessary to pump the osmotic agent and the supernatant through the second filtration unit 160.

In some embodiments, the dewatering system 100 further comprises a bypass valve 180 disposed between the first filtration unit 130 and the settling system 150 configured to divert the concentrate output of the first filtration unit 130 from the settling system 150 to the second filtration unit 160. In these embodiments the dewatering system 100 further comprises plumbing connected between the bypass valve 180 and the second filtration unit 160 to provide fluid communication therebetween. The dewatering system 100, in these embodiments, also comprises a controller (not shown) configured to direct the concentrate output from the first filtration unit 130 to the second filtration unit 160, bypassing the settling system 150, responsive to a system upset event, for example. A system upset event can be an event that agitates the initial biomass 110 in such a manner that the biomass will not settle in a reasonable time within the settling system 150. The bypass valve 180 can also be used to bypass the settling system 150 for other reasons, such as routine maintenance.

In those instances where the settling system 150 is bypassed, the concentrate output from the first filtration unit 130 enters the second filtration unit 160 through the supernatant input or another input into that side of the second filtration unit 160. Since the input to the second filtration unit 160 is more concentrated, so is the output from the biomass output, which can comprise biomass in suspension at a concentration of about 8% to about 12% by weight. Here, the biomass in suspension is not returned to the first filtration unit 130 but removed from the dewatering system 100 as the fully concentrated biomass 120 through a valve (not shown) in the return line between the second filtration unit 160 and the first filtration unit 130.

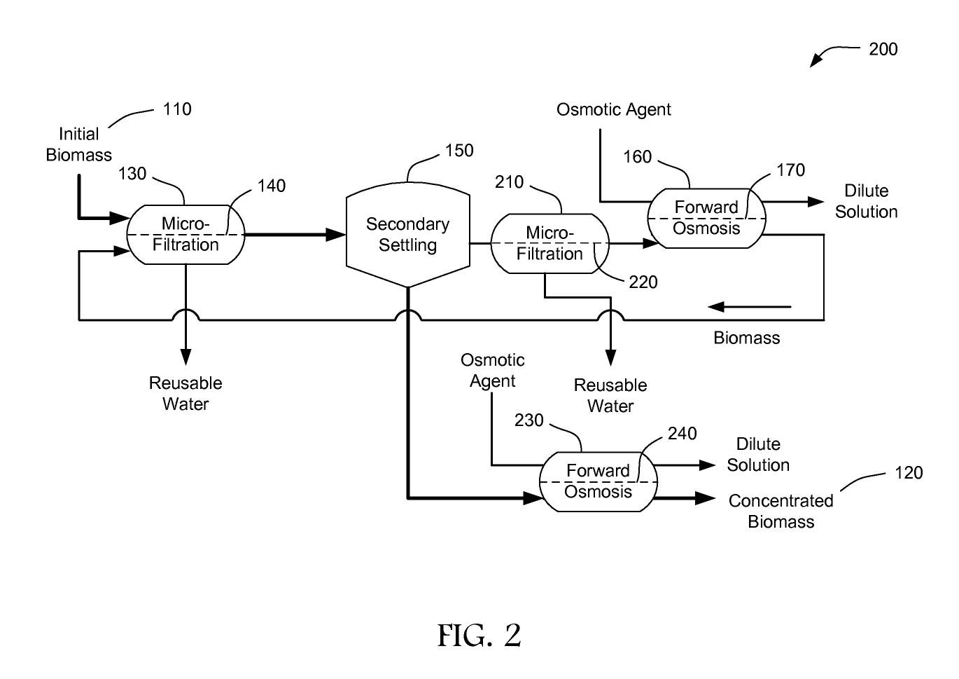

FIG. 2 illustrates another exemplary dewatering system 200 of the present invention for dewatering an initial biomass 110 in suspension. The dewatering system 200 is configured similarly to the dewatering system 100 and likewise comprises a first filtration unit 130 including a microfiltration membrane 140, a settling system 150, and a second filtration unit 160 including a forward osmosis membrane 170. Optional bypass valve 180 and associated plumbing can also be include in dewatering system 200 but are omitted from the drawing for simplicity.

Dewatering system 200 can comprise either or both of a third filtration unit 210 including a microfiltration membrane 220 and a fourth filtration unit 230 including a forward osmosis membrane 240. The third filtration unit 210 is disposed between the settling system 150 and the second filtration unit 160 in these embodiments, while the fourth filtration unit 230 is configured to receive the output from the settling system 150. The third filtration unit 210 is configured to pre-concentrate the supernatant from the supernatant output of the settling system 150. The fourth filtration unit 230 is configured to receive the output from the settling system 150 and to further concentrate the output from the solids output.

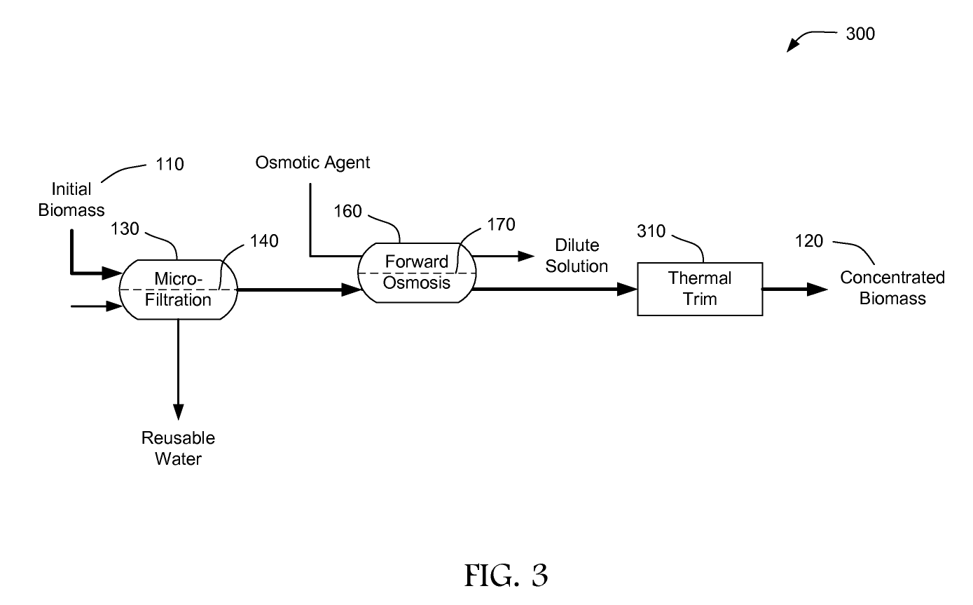

FIG. 3 illustrates still another exemplary dewatering system 300 of the present invention for dewatering an initial biomass 110 in suspension. The dewatering system 300 comprises a first filtration unit 130 including a microfiltration membrane 140 and a second filtration unit 160 including a forward osmosis membrane 170. The first filtration unit 130 also includes an input, a fresh water output and a concentrate output, while the second filtration unit 160 also includes a supernatant input coupled to the concentrate output of the first filtration unit, a draw solution input, a draw solution output, and a biomass output. A concentrated supernatant solution from the biomass output of the second filtration unit 160 is provided to a thermal trim unit 310. Thermal trim unit 310 is configured to heat the concentrated supernatant solution to drive off water from the concentrated supernatant solution to form a solid biomass product.

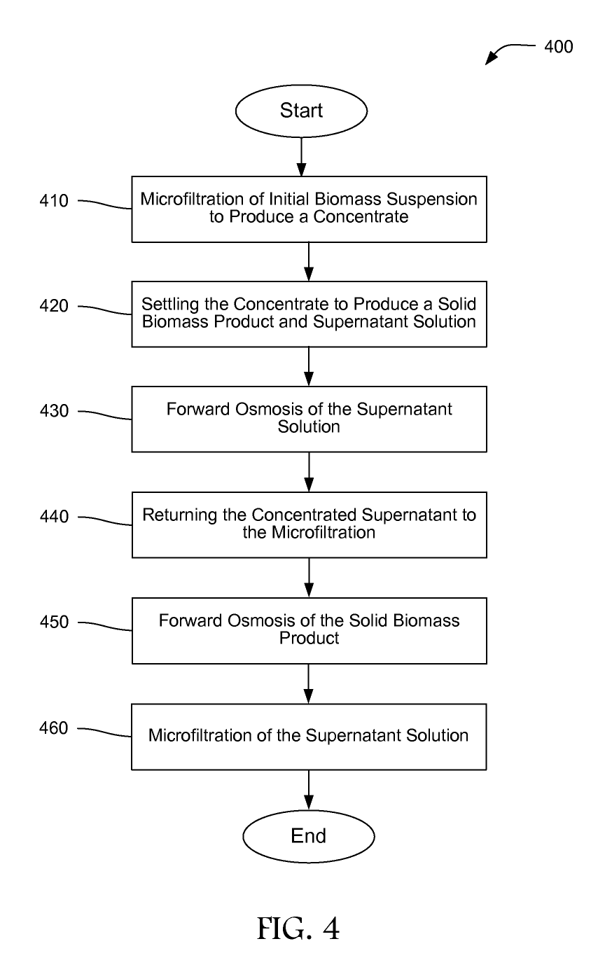

FIG. 4 illustrates an exemplary method 400 for dewatering biomass of the present invention. The method 400 comprises a microfiltration step 410, a settling step 420, a forward osmosis step 430, and a return step 440. Method 400 optionally also comprises a second forward osmosis step 450. The microfiltration step 410 includes filtering a low concentration suspension of biomass with a microfiltration membrane to produce clarified water and a concentrated suspension of biomass. For example, the low concentration suspension of biomass can have a concentration in a range of 0.1 g/L to 4 g/L, and the concentrated suspension of biomass can have a concentration in a range of 10 g/L to 40 g/L, in various embodiments. The microfiltration step 410 can be performed by a filtration unit including a microfiltration membrane such as first filtration unit 130.

The settling step 420 can be performed using compression settling, a settling tank, a settling pond, or a centrifuge, in various embodiments, to concentrate the suspension of biomass in order to produce a solid biomass product and a supernatant solution. For example, the solid biomass product has a concentration of 8% to 20% as dry mass product, in various embodiments. The dry mass product can be determined, in some embodiments, using the AWWA Standard Method Biostimulation (algae production) Evaluation subpart 8111G Test Conditions and Procedures part 4 Biomass Monitoring subpart a. Dry Weight: Method for evaluating algae in wastewater.

The forward osmosis step 430 comprises passing the supernatant solution and a salt solution across opposite sides of a forward osmosis membrane to produce a less concentrated salt solution and a more concentrated supernatant solution. The forward osmosis step 430 can be performed by a filtration unit including a forward osmosis membrane such as the second filtration unit 160. The return step 440 comprises adding the more concentrated supernatant solution from the forward osmosis step 430 into the low concentration suspension of biomass being fed into the microfiltration step 410.

In some embodiments, method 400 also comprises a second forward osmosis step 450. Step 450 comprises passing the solid biomass product from the settling step 420 and a second salt solution across opposite sides of a second forward osmosis membrane to produce a second less concentrated salt solution and a drier solid biomass product. In some embodiments, method 400 also comprises a second microfiltration step 460. Step 460 can comprise filtering the supernatant solution from the settling step 420 with a microfiltration membrane to remove further water therefrom prior to passing the supernatant solution and the salt solution across opposite sides of the forward osmosis membrane in the forward osmosis step 430.

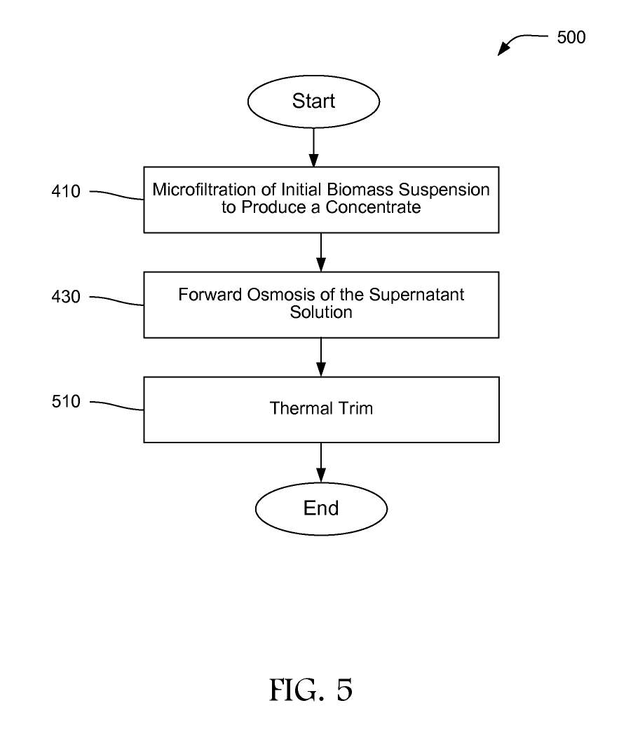

FIG. 5 illustrates another exemplary method 500 for dewatering biomass of the present invention. The method 500 comprises a microfiltration step 410 comprising filtering a low concentration suspension of biomass with a microfiltration membrane to produce clarified water and a supernatant solution of biomass, followed by a forward osmosis step 430 comprising passing the supernatant solution and a salt solution across opposite sides of a forward osmosis membrane to produce a less concentrated salt solution and a more concentrated supernatant solution, as generally described above. The method 500 further comprises a thermal trim step 510. The thermal trim step 510 comprises heating the more concentrated supernatant solution from the forward osmosis step 430 to produce a solid biomass product.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A dewatering system comprising:
a first filtration unit including a microfiltration membrane, an input, a fresh water output and a concentrate output;
a settling system including a solids collection system, an input coupled to the concentrate output of the first filtration unit, a solids output from the solids collection system, and a supernatant output; and
a second filtration unit including a forward osmosis membrane, a supernatant input coupled to the supernatant output of the settling system, a draw solution input, a draw solution output, and a biomass output coupled to the input of the first filtration unit.

2. The system of claim 1 wherein the microfiltration membrane includes pores with a pore size range of 0.45 μm±0.2 μm.

3. The system of claim 1 wherein the settling system comprises a compression settling system, a settling tank, or a settling pond.

4. The system of claim 1 wherein the solids collection system comprises a cone bottom tank or a bottom sweep system.

5. The system of claim 1 further comprising
a bypass valve disposed between the first filtration unit and the settling system,
plumbing connected between the bypass valve and the second filtration unit, and
a controller configured to direct the concentrate output from the first filtration unit to the second filtration unit, bypassing the settling system, responsive to a system upset event.

6. The system of claim 1 further comprising a third filtration unit including a microfiltration membrane and disposed between the settling system and the second filtration unit and configured to be used optionally to pre-concentrate the supernatant from the supernatant output.

7. The system of claim 1 further comprising a third filtration unit including a forward osmosis membrane and configured to optionally receive an output from the solids output of the solids collection system and further configured to concentrate the output from the solids output.

8. A method of dewatering biomass comprising:
filtering a low concentration suspension of biomass with a microfiltration membrane to produce clarified water and a concentrated suspension of biomass;
settling the concentrated suspension of biomass to produce a solid biomass product and a supernatant solution;
passing the supernatant solution and a salt solution across opposite sides of a forward osmosis membrane to produce a less concentrated salt solution and a more concentrated supernatant solution; and
adding the more concentrated supernatant solution into the low concentration suspension of biomass.

9. The method of claim 8 wherein the low concentration suspension of biomass has a concentration in a range of 0.1 g/L to 4 g/L.

10. The method of claim 8 wherein the concentrated suspension of biomass has a concentration in a range of 10 g/L to 40 g/L.

11. The method of claim 8 wherein the solid biomass product has a concentration of 8% to 20%.

12. The method of claim 8 further comprising passing the solid biomass product and a second salt solution across opposite sides of a second forward osmosis membrane to produce a second less concentrated salt solution and a drier solid biomass product.

13. The method of claim 8 further comprising filtering the supernatant solution with a microfiltration membrane to remove further water therefrom prior to passing the supernatant solution and the salt solution across opposite sides of the forward osmosis membrane.

14. A method of dewatering biomass comprising:
filtering a low concentration suspension of biomass with a microfiltration membrane to produce clarified water and a supernatant solution of biomass;
passing the supernatant solution and a salt solution across opposite sides of a forward osmosis membrane to produce a less concentrated salt solution and a more concentrated supernatant solution; and
thermally trimming the more concentrated supernatant solution to produce a solid biomass product.

15. The method of claim 14 wherein the low concentration suspension of biomass has a concentration in a range of 0.1 g/L to 4 g/L.

16. The method of claim 14 wherein the supernatant solution of biomass has a concentration in a range of 10 g/L to 40 g/L.

17. The method of claim 14 wherein the solid biomass product has a concentration of 8% to 20%.

18. A dewatering system comprising:
a first filtration unit including a microfiltration membrane, an input, a fresh water output and a concentrate output;
a second filtration unit including a forward osmosis membrane, a supernatant input coupled to the concentrate output of the first filtration unit, a draw solution input, a draw solution output, and a biomass output for producing a concentrated supernatant solution; and
a thermal trim system coupled to the biomass output and configured to heat the concentrated supernatant solution to drive off water from the concentrated supernatant solution to form a solid biomass product.

19. The system of claim 18 wherein the microfiltration membrane includes pores with a pore size range of 0.45 μm±0.2 μm.
